(19) United States
(12) Patent Application Publication
(10) Pub. No.: US 2020/0011097 A1
(43) Pub. Date: Jan. 9, 2020

(54) SECURITY LOCK FOR TRAILER CARGO COMPARTMENT

(71) Applicant: VLANTANA, UAB, Gobergiske (LT)

(72) Inventor: Vladas STONCIUS, Palanga (LT)

(21) Appl. No.: 16/438,641

(22) Filed: Jun. 12, 2019

(30) Foreign Application Priority Data
Jun. 12, 2018 (EP) 18177324.3

(51) Int. Cl. E05B 83/02; E05B 47/00; E05B 47/06

(52) U.S. Cl. CPC E05B 83/02; E05B 65/06; E05B 47/0603; E05B 47/0012

(57) ABSTRACT

Disclosed is a security lock for cargo compartment of a trailer. This solution is targeted to hermetically closeable cargo compartments (e.g., refrigerated cargo compartments) and includes at least one electromechanical lock mounted on the exterior side of the door. This locking solution is applicable to a number of cargo compartment doors produced by trailer companies, and with no substantial modifications in the original construction of the door due to the lock mounting. The lock provides several options of locking/unlocking, at least, by mechanical key, and continuous monitoring and locking/unlocking remotely from the central office with the use GPS and communication services (Internet/GSM/GPRS/satellite). The variety of mounting and locking options allows to adapt this solution and to protect the cargo from unauthorized access, on different trailers and logistics processes, for the entire trip of the cargo from the source to the destination.

### FIELD OF INVENTION

This invention relates to locking solutions of cargo compartments of trailers. More specifically, it relates to security lock for the door of hermetically closeable (e.g. refrigerated) cargo compartment, with the electro-mechanical lock mounted on the door from outside, and use of authorized locking/unlocking options, at least, mechanical key and remote locking-unlocking from the central office of the logistics, supplier and/or customer companies.

### BACKGROUND OF INVENTION

A need exists for a security locking system for hermetically closeable cargo compartment of a trailer that may be specified by:
Installation of the lock to be requested or technically limited with that on the external side of the door;
Lock construction has to be reliable and secure enough to prevent unauthorised access and thefts by opening or breaking the lock, or opening the door by overcoming an ineffective mounting of the lock;
Locking-unlocking authorisation and means have to obey to logistic processes that may require a variety of authorised persons/roles and different locking-unlocking options at any time and at any place. E.g. customs geofencing areas, locking/unlocking by the driver physically, locking/unlocking by the customer or logistics manager remotely, and so on).

Logistics companies use trailers and cargo containers for various applications, including trailers and containers that are used to transport goods and materials. Although the trailers and containers used in the trucking and cargo industry are expensive, the goods being transported therein, can often far exceed the value of the trailer or container itself. While pulling a trailer or cargo container carrier, the truck driver often needs to leave the trailer or container unmanned at a specified location. Cargo containers are often utilized as storage containers that are left at the same location for extended periods of time. All too often, unfortunately, thieves utilise the opportunity of a trailer or cargo container left alone, particularly if it is at a remote location, to steal the contents of the trailer or container. Once the thieves open the trailer or container doors, they quickly remove its contents and leave the area. Due to the nature of the crime and the goods stored therein, it is often difficult for the owner of the goods to regain possession of his or her property.

In light of the increased security risks and governmental oversight, unauthorised entry into and theft from trailers is a significant concern among those in the trucking and cargo container industry. As security devices become more complicated and more expensive, thieves become more sophisticated and more resourceful, making protection of an unmanned trailer or container very difficult and expensive. Devices have been developed that, when regularly and properly used, generally deter the would-be thief from stealing a vehicle, such as an automobile or truck, in part because of the amount of time and effort it takes to remove or get around the theft deterrent device. An example of devices that have been generally successful at reducing theft of vehicles are the various steering wheel lock devices that provide a bar across the steering wheel, making a movement of the steering wheel, and hence the vehicle, virtually impossible. While the steering wheel lock devices have worked well for, there exists a need for a device that prevents entry into a trailer or cargo container in order to protect the owner's investment in the goods stored therein and to prevent sensitive materials falling into the possession of dangerous individuals or groups.

To prevent the theft of materials from inside a trailer or cargo container left or stored at protected or unprotected locations, trailer and container owners typically use exterior mechanical locking devices, such as padlocks and the like, and seals that are designed to physically prevent entry into the trailer or container. As those in the trucking industry know, experience has proven that the devices currently in use can be overcome relatively easily by the determined and resourceful thief, particularly one with a good set of bolt cutters. In addition to being relatively easy to overcome, the devices are useless if the truck driver or container operator (i.e., a person having authority to open the container to remove the contents or conduct an inventory check) forgets to set the locks. Even when the driver or operator does set the lock or locks, problems can arise if the next authorized driver or operator does not have the correct key or combination and is forced to break the lock to gain entry into the trailer or container, thereby rendering the security system useless. In areas where a number of people may need access to the contents of a trailer or container, the ability to ensure that the right person has the necessary key or combination to gain entry into the trailer or container can be challenging.

Although the various theft deterrent devices currently available have some ability to prevent theft of materials from inside a trailer or cargo container, they have disadvantages and limitations that prevent wide acceptance or effective theft deterrence. One of the most common problems with a presently available trailer or container security devices is the need to rely on human operation to set or reset the security device. What is needed, is an easy to use and effective theft deterrent or locking device that allows a trailer or container owner to quickly and securely lock the trailer or container door in order to prevent unauthorized entry into the trailer or container. The preferred locking device will automatically secure the door, without the need for the human element to set the lock, and maintain the door in a locked condition until such time as an authorized individual opens the door. The preferred device will facilitate wireless communication for reporting on the door status (i.e., locked/unlocked or open/closed) and remote operation of the locking mechanism.

The analysis of the prior art revealed much security locking solutions for cargo trailers patented or at least with patent applications published.

The prior art sources U.S. Pat. No. 9,683,394, EP2562333, US2011316683, US2004055345, US2007109097, US2010257904, U.S. Pat. No. 8,493,193B2 disclose security locking solutions with remotely managed locks of cargo compartments. However, all these solutions describe lock mechanism installations inside of the cargo compartment that makes their use more complicated for a hermetically closeable door as per current application.

The prior art sources WO2005083648 and US2008061924 disclose solutions for remotely electronically managed locking/unlocking of the trailer. In WO2005083648, a security system is provided for a cargo container having a door. An electronic control unit is provided for monitoring the locked status of the door. The electronic control unit is operably communicable with a remote computer terminal. A first software control program is located within the electronic control unit to monitor the locked status of the door. A second software control program is located within the remote computer terminal and is capable of retrieving activity and functions from the first software control program. A protocol is provided to facilitate communication between the electronic control unit and the remote computer terminal. In US2008061924, a multiple lock cargo security system, comprising: a master security device including position sensors, a motor, a door sensor and a latch; a master controller connected to the position sensors and the door sensor; at least one slave security device having a slave controller connected to the master controller; and a computing device for communicating with the master controller through a wireless communication link, to move the security system locking devices to a locked or unlocked position. However, these sources, while covering broadly the locking as complex solutions, further emphasize more the part of the electronic control of the lock, and explains less enough the properties and mounting details of the electromechanical lock itself.

The prior art source U.S. Pat. No. 5,640,139 describes a solution of Wireless control of electronic door locking devices for trailers. A system for preventing theft of cargo from a cargo area of a truck is disclosed. The system includes a lock for locking shut a door to the cargo area of the truck when the lock is engaged. The lock allows the door to the cargo area to be opened when the lock is disengaged. A receiver receives a signal from a remote location. The lock is controlled in response to the signal received from the remote location such that the lock is disengaged when the signal received from the remote location is indicative of predetermined information. However, in the current application GPS and communication system are considered to be located in the trailer but not in the truck. Also, the mechanical and mounting features of the electromechanical lock itself are not detaily disclosed in U.S. Pat. No. 5,640,139.

The prior art source CN204163497 discloses a locking solution with electronically and remotely monitored and managed paddock on the exterior of the door. An electronic seal lock capable of being monitored remotely comprises a lock shell and a steel wire rope lock beam. The steel wire rope lock beam is provided with a fixed end connected with the lock shell and a free end matched with a lock hole. A spring bolt block and a spring bolt block driving mechanism are arranged inside the lock shell, and the spring bolt driving mechanism comprises a motor and a lead screw nut mechanism, and a power source and a controller are arranged inside the lock shell. A lock beam state detection device comprising a solenoid coil and a Hall component is arranged between the free end and the lock shell, the solenoid coil is arranged inside a hole in the free end, and the Hall component is installed inside the lock shell. A GPRS communication technology, the lock beam state detection device, an encryption technology and the mechanical structure are combined to form the electronic seal lock capable of monitoring the state of a container shipping truck in real time. Sealing and unsealing information can be automatically recorded at any time, unauthorized unsealing and lock beam cutting information is recorded, the information can be transmitted to a remote control center server instantaneously through a wireless communication module, and therefore monitoring and management are achieved. However, this solution is more susceptible in case of break-in than other parts of a trailer like walls, doors, hinges. Therefore, considered as not secure enough.

The prior art source US2002123917A1 discloses a similar logistic process wherein the said electromechanical lock is intended to be used (method and apparatus for providing a proof of delivery verification for freight transportation systems); moreover, the customs geofencing areas with the said lock are considered for the locking/unlocking remotely the door of the trailer. A method and apparatus for providing a proof of delivery verification for freight transportation systems. A vehicle transmits an indication of arrival at a destination. A remote station receives the indication and validates the arrival of the vehicle. If the arrival is validated, a proof of delivery verification of a delivery associated with the arrival is provided to a shipper, carrier, or other interested parties. However, US2002123917A1 does not disclose enough the electromechanical and mounting properties of the lock, as it should be considered by the current application.

### SUMMARY

The door lock for trailers and cargo containers of the present invention solves the problems identified above. That is to say, the present invention discloses a new and useful locking device that effectively prevents unauthorised entry through a trailer or container door. The door lock device of the present invention is adaptable to new and existing trailers, is easy for the truck driver or container operator to engage and is difficult for the thief to overcome or disable.

To eliminate the drawbacks indicated above, this invention provides a solution of a secure lock with authorised door locking-unlocking of the hermitized cargo compartment of the trailer. The solution is specific to these options:
Installation of the lock is from outside of the door only. This limitation is set by specific cargo compartments which have the construction with isolated walls and the hermetically closeable door that mostly complicates the installation of the locking mechanism inside of the compartment (although, that could deem to be more secure option as the lock is not accessible from outside). For example, refrigerated cargo compartments in trailers;
Nevertheless, the exterior lock construction has to be secure enough not to allow the lock as a weaker option of break-in than any other construction components of the cargo compartment, i.e., door, wall panels, hinges of the door, native locking solutions that come with the trailer from the factory, etc.;
Different door configurations are available from producers; therefore, the lock mounting location can be variable too, depending on the configuration of the door;
Authorization options to lock and unlock the compartment should be secure enough to allow locking-unlocking of the door only by authorized staff; however, there should be a possibility to lock and unlock the door in any time when logistic processes require it. It means, the construction of the lock should not provide weak options to open the compartment by non-authorized staff and should provide all sufficient options to open it in any time by the authorised staff (driver, logistics dispatcher from the central office, or responsible manager of the logistics processes).

The above and other objectives of the present invention are explained in greater detail by reference to the attached figures and the description of the preferred embodiment which follows. As set forth herein, the present invention resides in the novel features of form, construction, mode of operation and combination of processes presently described and understood by the claims.

### DESCRIPTION OF DRAWINGS

To disclose the invention and its practical applications, the following pictures are provided and referenced hereafter. Figures are given as examples only and in no way shall limit the scope of the invention.

FIG. 1 illustrates the embodiment of the locking solution and the electromechanical lock (1) in the scope of logistics process;

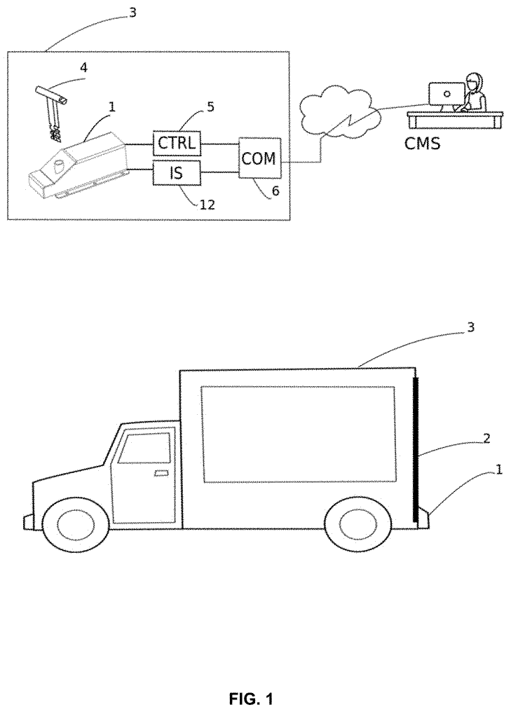

FIG. 2 illustrates the internal construction of the electromechanical lock. The construction comprises the lock basement (7), electro-mechanical threaded drive (11), lock tongue (9), lock-tongue springs (18), protected tongue-loop (8) welded to the door jamb (17), mechanism of the lock (10), key-hole (15) and key-hole plug (16), mechanical key (4), external welded stainless steel cover to protect the lock mechanism (13), sensor of the locking position (12);

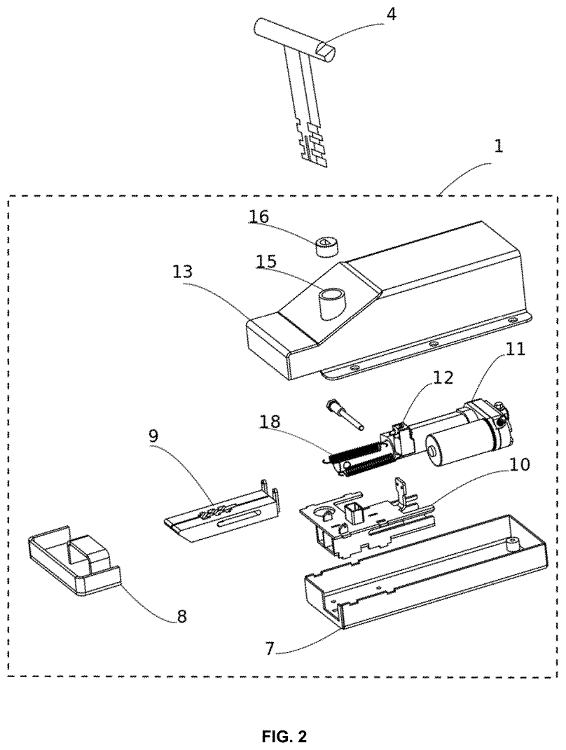

FIGS. 3A and 3B illustrate the electro-mechanical lock (1) mounted on the outside of the door (2, 21) of the refrigerated cargo compartment (3) of the trailer and the jamb (17) of the door (2, 21); specifically, FIG. 3A illustrates the door (2) with two vertically openable door-halves (21, 22) which partly cover each other in the closed position and FIG. 3B illustrates the door (2) with two vertically openable door-halves (21, 22) which do not block each other in the closed position, therefore, the second door-half (22) is addi-additionally reinforced with a stainless steel tongue (24).

### DETAILED DESCRIPTION OF PREFERRED EMBODIMENTS

The most preferred embodiment of the present invention is electro-mechanical lock comprising at least of the lock basement (7), electro-mechanical threaded drive (11), lock tongue (9), lock-tongue springs (18), protected tongue-loop (8) welded to the door jamb (17), mechanism of the lock (10), key-hole (15) and key-hole plug (16), mechanical key (4), external welded steel lock cover (13) to protect the internal construction of the lock.

Mechanical Part:
The lock operates by the principle of an ordinary lock—the linear drive (11) sets down the lock-tongue (9) into tongue-loop (8), by thus fixing the position of the door (2, 21) and not allowing to open it. Also, the linear drive (11) can keep the lock-tongue (9) in the raised position that means the lock and door opened. The linear drive (11) is implemented as the threaded linear drive that means, the electrical power is needed only during locking or unlocking actions, and no electrical power is required to keep lock-tongue (9) in any of its static positions.
The emergency unlocking provides the possibility to open the lock with the help of key (4) with a specific shape when it is not possible to open the lock remotely by logistics operator. The principle is: the key raises up the lock-tongue (9) and opens the door (2, 21).

Electrical Part:
Linear threaded drive (11), which is responsible for moving the lock-tongue (9);
Inductive sensor IS (12) of the lock-tongue position; is installed near the “opened” position of the lock-tongue (9) and sends electrical signal “opened” to the tracking module (6) when the lock-tongue opens the lock;
The controller of the linear threaded drive CTRL (5)—receives the control signal from the tracking module (6) and defines the direction of movement of the linear drive (11); in other words, changes polarity of control of the linear drive, dependently on the control signal received;
Tracking module COM (6)—any type, having 2 digital outputs. Accepts control signal from the central management system (CMS) and transmits it to the controller of the linear drive (5). Also, it accepts digital signal from the inductive sensor (12) and transmits it to the central management system (CMS).

Software Part:
The lock can be opened from the central management system (CMS) of the company. The signal is transmitted via communication services to the tracking module (6) of the lock;
The system indicates the attempt to open the lock;
If the opening attempt successful—the signal “opened” is transmitted from the inductive sensor (12) to the central management system (CMS) and the state of the lock is identified.

The lock mounting options are possible in different places along the perimeter of the door (2, 21, 22) and jamb frame (17). However, the most effective mounting position should be considered for different door configurations and security level.

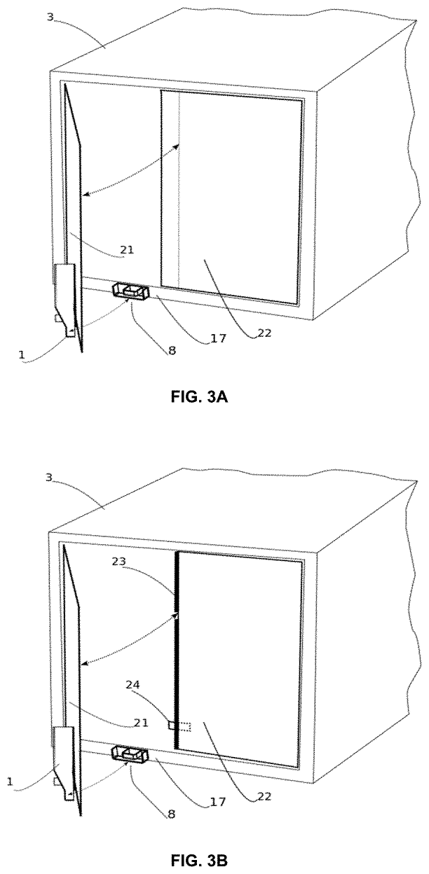

In the most preferred embodiment (FIG. 3A), the door (2) is considered to have two vertically openable door-halves (21, 22), which partly cover each other in the closed position. Thus, one door-half (21), when being closed, also blocks the second door-half (22). Therefore, the mounting of the lock is recommended at the bottom of the covering door-half (21), where the best door blocking result is achieved, and also it is the most convenient position to access the lock for the authorised person with the mechanical key (4). Meanwhile, the protective stainless steel cover (13) is considered to provide enough protection against non-authorized persons to access and open the lock and the door.

In another practical embodiment (FIG. 3B), the originally made door (2) also comprises two vertically openable door-halves (21, 22). However, these halves do not block each other firmly in the closed position because the second door-half (22) has only a rubber edging (23) to be covered by the first door-half (21). Said rubber edging (23) allows to open the second door-half (22) only if the first door-half (21) is opened. However, this rubber edging (23) is somewhat vulnerable to cutting it from outside (e.g. by a knife) and, therefore, it provides a security breach for unauthorised access. For this type of the door, the mounting of the lock is recommended at the bottom of the covering door-half (21), and also, the second door-half (22) is additionally reinforced with a stainless steel tongue (24), fixedly mounted (e.g. rivet clinched or welded) from inside of the second door-half (22), in order the first door-half (21) to block firmly the second door-half (22) (FIG. 3B).

The electrical wiring from the lock can be effectively guided into the interior side of the door through small and later hermetically sealed holes that would not affect total hermetic properties of the cargo compartment.

In the most preferred embodiment, a variety of methods of the door locking/unlocking are considered, at least, these:
The driver of the truck may be granted with the mechanical key, kept in a secret and secured place of the truck.
The lock is connected to the GPS tracking and communication system of the trailer that would enable configurable options for locking/unlocking the door of the trailer, at least:
   Pre-programmed automatic locking/unlocking of the door according to the GPS coordinates at customs geofencing areas, as may be required by customs procedures in some cases;
   Locking/unlocking remotely by a dispatcher of logistics company who is responsible for freight management from the source to the destination;
   Locking/unlocking remotely by the supplier and/or client authorised persons who are granted, correspondingly, to lock and unlock the trailer's door at the moments of delivery and arrival of the freight;

The management methods of the lock are provided as examples of real practices only. However, the given examples should not limit the application scope of this invention to a broader field of logistics processes.

1. A security lock for trailer cargo compartment door comprising at least
an electromechanical locking mechanism is mounted on the door of the hermetically closeable cargo compartment of the trailer,
wherein said electromechanical locking mechanism has means to interface it to communication means for remote monitoring and locking/unlocking,
characterized in that said electromechanical locking mechanism is arranged on the external side of the door, at the door perimeter, and a tongue-loop of the lock is arranged on the jamb of the door, in such a way that during locking the tongue of the lock extends into the tongue-loop,
wherein said security lock provides at least two locking/unlocking options: a mechanical key and locking/unlocking remotely using digital communication means.

2. The security lock according to claim 1, characterized in that it further comprises an electronic interface to monitor the status of said security lock continuously, both locally and remotely.

3. The security lock according to claim 1, characterized in that it has means to interface said security lock to communication systems for remote management from the central office by the use of Internet, GPS, GPRS and satellite connections.

4. The security lock according to claim 1, characterized in that said electromechanical locking mechanism uses threaded linear drive for locking/unlocking, wherein use of electric power is applied during the locking/unlocking action only.

5. The security lock according to claim 1, characterized in that said electromechanical locking mechanism and the tongue-loop are fixedly mounted, respectively, at the bottom part of the door and at the bottom part of the jamb.

6. The security lock according to claim 1, characterized in that it further comprises a protective stainless steel case which is fixedly mounted or welded onto the electromecahnical locking mechanism and extends over the jamb to cover the tongue-loop.
